(19) United States
(12) Patent Application Publication
(10) Pub. No.: US 2014/0272235 A1
(43) Pub. Date: Sep. 18, 2014

(54) SELF-CHARGING ELECTROSTATIC ADHESIVE ASSEMBLIES

(71) Applicant: Steven N. Kruchko, Western Springs, IL (US)

(72) Inventor: Steven N. Kruchko, Western Springs, IL (US)

(21) Appl. No.: 13/840,932

(22) Filed: Mar. 15, 2013

(51) Int. Cl. C09J 11/00; C09J 7/02; B29C 65/48

(52) U.S. Cl. CPC C09J 11/00; B29C 65/4805; C09J 7/0225
USPC 428/40.2; 156/273.1; 428/41.8

(57) ABSTRACT

An adhesive assembly includes a film having a top and bottom surface. An activatable adhesive is disposed on the bottom surface of the film. A release liner is applied to a surface of the adhesive, opposite the film. The release liner and the activatable adhesive being configured to electrostatically charge the activatable adhesive upon removal of the release liner from the adhesive.

### RELATED APPLICATIONS

Not applicable.

### BACKGROUND

The present technology relates to adhesive assemblies, such as graphic sheets and tapes, that electrostatically adhere to substrates. More specifically, the present invention relates to adhesive assemblies that adhere to substrates using a combination of electrostatic charge and an additional adhesive, where the adhesive assemblies are self-charging through contact electrification.

Films have been provided with electrostatic charges, so that they will adhere to substrates without the use of adhesives. Films having persistent dielectric polarization are called electrets.

U.S. Pat. No. 5,258,214 discloses a preprinted thin plastic film wall covering having a preprinted image thereon and provided with a static electrical charge for securing the coverings to a surface.

U.S. Pat. No. 5,207,581 discloses a writing apparatus including electret film. The electret film, a flexible plastic film having a static electrical charge induced thereto, is capable of being erasably written upon with dry erase markers, as a writing medium. An apparatus is described for holding a roll of electret film.

U.S. Pat. No. 5,989,685 (“685 patent”) discloses an electret film composition adapted for printing on inkjet printers. The 685 patent purports to provide an “improved printing material that incorporates the advantages of electrets (sic)” (Id. at 2: 37-39.) According to the 685 patent, the electrets hold “the promise of providing a display which sticks to a surface without the use of fasteners or adhesives.” (Id. at 1: 53-55.) The charged sheets of the 685 patent are attached to a paper backing to avoid problems with handling of the sheets in the paper feed mechanisms of printers. These carrier backing papers are adhered to the sheets with a glued edge. (Id. at 4: 24-52.)

U.S. Pat. No. 5,807,624 (“624 patent”) discloses an electrostatically charged imaging manifold. The preferred imaging manifolds “comprise a transparent, polymeric sheet imageable in an imaging sheet, and attached thereto, an opaque member underlying and in register with said transparent sheet, said opaque member being adhered to said transparent polymeric sheet by means of the combination of an electrostatic charge and a pressure-sensitive adhesive.” (624 patent at 3:55-60.) This adhesive is used to provide additional protection against “scrunch,” or to improve feeding performance of the sheet with the carrier paper. (Id. at 12:66-13:2.)

U.S. Pat. No. 6,023,870 (“870 patent”) describes an apparatus for displaying and replacing graphic sheets on vending machines, wherein graphic sheets are removably adhered to the reverse side of the clear display panel by static cling. An alternative embodiment is disclosed at column 7, lines 38-50, which describes the use of partial adhesive or reusable adhesive, defined as a “tacky” adhesive, for the removable adhering function.

U.S. Pat. No. 6,660,352 (“352 patent”) discloses a graphic sheet comprising a film having a pre-applied, activatable adhesive, such as a pressure activated adhesive, a/k/a pressure sensitive adhesive (PSA). The sheet also carries an electrostatic charge. In use, the electrostatic charge is used to temporarily adhere to the sheet on substrate, such as a wall. The electrostatic charge allows the applicator of the graphic sheet to adjust the orientation and position the graphic sheet on the substrate before activation of the activatable adhesive. Once the graphic sheet is in the desired position on the substrate, the applicator can activate the adhesive to further secure the graphic sheet to the substrate.

In the above patents, the electrostatic charge is applied to the sheets as part of the manufacturing process. Additives that are often desired in films such as whiteners, colorants, fire retardants, etc. can cause the charge to dissipate. In addition, a variety of outside factors can also cause the charge to dissipate. These factors include humidity, heat, hydroscopic coatings, inks, etc. The rate at which this dissipation occurs can also be effected by factors including heat, humidity, and printing processes (including inks and coatings), for example.

The 352 patent purports to address this charge dissipation issue through the use of an activatable adhesive layer. However, the 352 patent suffers from numerous drawbacks. For example, like the other patent described above, the electrostatic charge of the 352 patent is applied as part of the manufacturing process. As a result, the charge in the 352 patent can dissipate over time, thereby limiting the shelf-life of the product. Further, in the 352 patent, the charge is applied to the face stock, which can attract dirt to the face stock. In particular, particles floating in the air can be attracted and adhere to the electret, making it look dirty. Additionally, the electrostatically charged face stock of the 352 patent has an adhesive on its bottom surface. Because the adhesive is interposed between the face stock and the display substrate, the adhesive blocks the polarized charge from the wall. With the adhesive blocking the polarized surface, there is a weaker polarized bond, which can limit the weight of material that can be supported by the charge.

### SUMMARY

According to at least one embodiment of the present technology, an adhesive assembly includes a film having a top and bottom surface. An activatable adhesive is disposed on the bottom surface of the film. A release liner is applied to a surface of the adhesive, opposite the film. The release liner and the activatable adhesive being configured to electrostatically charge the activatable adhesive upon removal of the release liner from the adhesive. In at least some embodiments, the activatable adhesive and the release liner may both be insulating materials. The electrostatic charge may be applied to the activatable adhesive through contact electrification.

According to at least some embodiments, the electrostatic charge is sufficient to support the adhesive assembly on a vertical clean insulated surface. In some embodiments, the electrostatic charge has surface charge density is in the range of about ±0.01 μC/m² to about ±30 μC/m², and more particularly, in the range of about ±0.5 μC/m² to about ±10 μC/m², and more particularly, in the range of about ±2 μC/m² to about ±5 μC/m².

According to certain aspects of the present technology, the adhesive may be selected to maintain at least a predetermined charge for at least a predetermined amount of time. The desired surface charge density may vary as a function of the particular application to which the technology is applied. In some embodiments, such as a wall paper, for example, the adhesive maintains a surface charge density sufficient to support the adhesive assembly on a vertical surface, such as a wall, for at least a predetermined minimum time, such as 5 minutes, for example.

According to certain embodiments of the present invention, the activatable adhesive may be a pressure sensitive adhesive. In some embodiments, the pressure sensitive adhesive may be a pressure sensitive repositionable adhesive. In some embodiments, the pressure sensitive adhesive may be a pressure sensitive positionable adhesive. In some embodiments, the pressure sensitive adhesive may include non-tacky projections from a pressure sensitive adhesive surface. In some embodiments, the pressure sensitive adhesive may be microencapsulated.

According to certain embodiments of the present technology, the activatable adhesive covers from about 10% to about 100% of the bottom surface of the film, and more particularly, from about 50% to about 100% of the bottom surface of the film, and more particularly, from about 80% to about 100% of the bottom surface of the film.

In some embodiments, the activatable adhesive may be a pattern coated on the bottom surface of the film. For example, the adhesive may be applied in a grid, strips or other pattern.

In some embodiments of the present technology, the activatable adhesive is a heat-activated adhesive.

According to certain aspects of the present technology, the adhesive assembly may be applied to a surface by a) electrostatically charging the activatable adhesive through contact electrification by removing the release liner from the sheet; b) applying the bottom surface of the film to the intended location on the display substrate, thereby temporarily adhering the sheet to the display substrate through the electrostatic charge of the film; c) orienting said sheet on the display substrate; and d) securely adhering the sheet to the display substrate by activating the activatable adhesive.

At least some embodiment of the present technology relate to a two-stage pressure sensitive adhesive assemblies, such as graphic sheets. In the first stage, the adhesive assembly temporarily adheres to a display surface, such as a wall or billboard or other surface, by a polarized charge. The adhesive is charged when a release liner is removed from the adhesive at the time of installation. The polarized charge enables the adhesive assembly to be repeatedly slid and repositioned. In the second stage, pressure is mechanically applied to the adhesive to form at least a semi-permanently bond between the adhesive assembly and the display surface.

Some embodiments of the present technology relate to rolled tapes. In one embodiment, the tape has a pattern, such as a micro-embossed pattern, on its top surface and an activatable adhesive on its bottom surface. When the tape is rolled, the pattern from the top surface is transferred to the adhesive, which reduces the tack of the adhesive until it is activated, e.g., by pressure. As the tape is unrolled by the end-user, the adhesive is charged by contact electrification. The combination of the electrostatic charge and the embossed adhesive allows the tape to be applied and repositioned on a surface prior to activation of the adhesive.

According to at least one embodiment of the present technology, the adhesive may have a tackiness that increases over time.

The present technology has a wide variety of applications, including but not limited to, wallpaper, decals, stickers, highway stripping tapes, automobile pin-stripping tapes, vehicle wraps, billboards, die cut decals, decorative laminations, floor decals, ceiling decorations, labels, point of purchase displays, dry erase white boards, protective films, etc.

### BRIEF DESCRIPTION OF THE DRAWINGS

FIGS. 1 and 2 illustrate an embodiment of an adhesive assembly according to at least some aspects of the present technology.

### DETAILED DESCRIPTION

An adhesive assembly according to certain aspects of the present technology is constructed by taking a top layer face stock, applying a second layer of activatable adhesive, and then a bottom layer called a release liner. Examples of activatable adhesives include pressure sensitive adhesives and heat activated adhesives. The activatable adhesive may be designed to be non-tacky to the touch and build strength over time. According to at least some embodiments, the activatable adhesive is formulated with non-polar, insulating, polymers. The adhesive may remain electrically neutral until just before the adhesive assembly is applied. An electrical charge is generated when the release liner is separated from the insulating adhesive in a physical process known as contact electrification. As a result, the originally neutrally charged adhesive receives a strong electrical polarized field that is electrically attracted to other surfaces. The materials of the graphic sheet may be selected from different positions in the triboelectric series so that the electrical charge of the adhesive is sufficient to support the adhesive assembly on a smooth, clean insulative surface, such as a vertical wall, ceiling, billboard, car body, truck siding, furniture, window, or appliance, for example. Since the adhesive is designed to be non-tacky, the adhesive assembly can be easily moved around on the installation surface until it is in the desired orientation/position. Once the adhesive assembly is in the desired position, it can be more permanently secured to the surface by activation of the adhesive. For example, in some embodiments, the activatable adhesive may a pressure-sensitive adhesive that is activated by pressure, and the adhesive may be activated by applying pressure to the sheet at the location of the adhesive after orienting/positioning the sheet on the display substrate. In certain other embodiments, the activatable adhesive may be a heat activated adhesive, and the adhesive may be activated by applying heat (e.g., using a hair dryer) to the sheet after orienting the sheet on the display substrate.

According to at least some embodiments, the adhesive assembly 10 comprises a face stock 12, an activatable adhesive 14 and a release liner 16. The face stock 12 includes a top surface 18 and a bottom surface 20. The adhesive is applied to the bottom surface 20 of the face stock 12. The release liner is applied to the bottom surface of the adhesive, opposite the face stock 12.

The face stock 12 may be constructed from a variety of materials depending on the intended use of the adhesive assembly 10. In some embodiments of the present technology, the face stock 12 may be a polymer film or cellulose sheet, such as paper or polymer impregnated cellulose sheet.

In at least some embodiments of the present technology, the adhesive assembly 10 does not carry an electrical charge until the charge is created when the release liner 16 is removed, e.g., peeled off of the adhesive assembly 10. When the release liner 16 is removed, e.g., peeled, from the adhesive 14, the electrostatic charge in FIG. 2 is generated by contact electrification. The charge on the adhesive will have a magnitude equal to the charge on the release liner and the polarity is opposite.

The adhesive 14 and release liner 16 formulations are chosen so that when these components are separated, the charge that is seperated by contact electrification is suitable for this application. According to at least one embodiment of the present technology, the adhesive may be polyisobutylene and the release liner may be polyethylene or polypropylene. According to at least some embodiments, the magnitude of the charge on the adhesive 14 may be on the order of about ±0.01 μC/m² to about ±30 μC/m², and more particularly, in the range of about ±0.5 μC/m² to about ±10 μC/m², and more particularly, in the range of about ±2 μC/m² to about ±5 μC/m².

According to at least some embodiments, the charge on the release liner 16 will have the same magnitude and have the opposite polarity to the charge on the adhesive 14.

The surface electrical resistivity of adhesive 14 and the release liner 16 should be sufficient so that the charge can separate, that is, so that the charge will not flow along the surface and recombine at the peel line (line of contact) during the peeling process. According to at least some embodiments, the surface electrical resistivity of both the adhesive and release liner is greater than at least about 1×10⁺⁶ Ohms per square as measured by ASTM D257 Standard Test Methods for DC Resistance or Conductance of Insulating Materials.

By using contact electrification, the structure in FIG. 2 is charged at the time of usage. In most applications, the charge only needs to persist for a relatively short period of time. For example, in many applications the charge only needs to persist long enough to temporarily secure the adhesive assembly to a substrate, such as a wall of the body of a vehicle, so that the installer can position and orient the adhesive assembly in the substrate before activation of the adhesive to more permanently securing the graphic in place. According to some embodiments, the adhesive maintains an electrostatic charge at least about ±2 μC/m² for at least about 1 minute, and more particularly, for at least about 5 minutes, and more particularly, for at least about 15 minutes.

The pre-charged electret films discussed in the background section have a limited “shelf life” because the charge dissipates over time. As discussed above, a number of environmental factors, such as heat and humidity, can affect the rate at which the charge dissipates. In addition, the volumetric resistivity of the charged material impacts the shelf life because the rate of dissipation is proportional to the volumetric resistivity of the material. Increasing the volumetric resistivity through material selection can increase the shelf-life for the pre-charged product, but it limits the range of acceptable polymers. In contrast, because the adhesive is charged (by contact electrification) just prior to installation of the adhesive assembly, the adhesive does not need as high volumetric resistivity as would be required if the charge were applied at the time of manufacture. In some embodiments of the present technology the volumetric electrical resistivity of the PSA may be less than about 1×10⁺¹⁶ Ω-meter as measured by ASTM D257 Standard Test Methods for DC Resistance or Conductance of Insulating Materials.

An electrostatic charge can be separated when two surfaces come into contact and separate, where at least one surface has high resistance to electrical current (i.e., an electrical insulator). When two materials are in contact, electrons may move from one material to the other, which leaves an excess of positive charge on one material, and an equal negative charge on the other. When the materials are separated, they retain this charge imbalance even when the two materials are far removed from one another.

In general, the polarity and strength of the charge on a material once they are separated depends on the relative positions in the triboelectric series. However, when surfaces of identical materials are contacted and separated, charge transfer occurs such that one surface charges net positive and the other surface charges net negative. This is the idea behind static cling sandwich wrap film, which attains much of its “cling” due to electrostatic charge developed by unwinding the film.

According to certain aspects of the present technology, the adhesive 14 and release liner 16 may be constructed so that the electrostatically charged adhesive maintains its charge for at least a predetermined time. For example, the time may be selected to permit application and repositioning of the adhesive assembly to a surface using the dielectric charge before more permanently securing the adhesive assembly in place by activation of the adhesive.

According to certain aspects of the present technology, the adhesive 14 and release liner 16 may be constructed to provide the adhesive with at least a predetermined charge. For example, the charge may be selected to ensure that the adhesive assembly can be temporarily and removably adhered to a surface, such as a wall, via the electrostatic charge. The degree of charge will depend on the nature of the adhesive and the release liner that are used. In general, a greater degree of separation on the triboelectric series will provide a greater degree of charge on the adhesive surface.

The charged adhesive will lose its charge based on, among other things, the insulating characteristics of the adhesive. Thus, according to certain aspects of the present technology, the adhesive's base polymer and all of its components may be selected to be an insulator. According to certain embodiments, the adhesive may be non-hydroscopic to reduce the charge dissipation effects from moisture, e.g., humidity, as adsorbed moisture from the relative humidity will quickly dissipate any charge.

A wide variety of materials can be used for the adhesive and the release liners. In general, it is desirable that the adhesive be a good insulator. In this regard, according to certain embodiments of the present technology, the adhesive may be a material that is greater than about 10⁺⁶ ohms per square surface resistivity and 10¹⁰ Ohm-meters volume resistivity.

Suitable pressure sensitive adhesive materials include silicones, polyacrylates, polybutadiene, polyisoprene, and polymers selected from groups including, polyisobutylene, thermoplastic rubbers, polybutenes polyamide, ethylene vinyl acetates, styrene block co-polymers, hydrocarbon elastomers, elastomeric block copolymers, blends and combinations thereof. According to some embodiments, the preferable adhesives may include polyisobutylene blends or styrene-butadiene copolymers. Both polyisobutylene and styrene-butadiene copolymers are conventionally used in pressure sensitive adhesives, and their tack and degree of adhesion can be modified by suitable blending of different molecular weight polymers or by addition of tackifying agents. Both polyisobutylene and styrene-butadiene block copolymers can be applied to a substrate carrier via solvent solution or hot melt.

According to certain aspects of the present technology, the preferred adhesives may be those that are not based on water emulsions. Waterborne adhesives are generally hydroscopic and, as a result, are not as typically as good of insulators as those adhesives that can be applied as solvent borne or hot melt systems.

A series of experiments were developed to show the following:
An adhesive made of nonpolar insulating polymers can be polarized by contact electrification
This same polarized adhesive can be used as a pressure sensitive label if the release liner and face stock are designed to be compatible with the dielectric properties of the adhesive.
This same polarized pressure sensitive label can adhere to a smooth wall by simple electrical forces if the adhesive is designed to have a no tack surface.

Test Data:

The adhesive used for many of the tests is a polyisobutylene (PIB) made by BASF. PIB is commonly used to make adhesives; it is the building block of many different types of PSA's. PIB's made under the Oppanol® product line have good dielectric properties (e.g., dielectric constant of 2.2 and dissipation factor of less than 5×10⁻⁴ at 60 Hz.) The material is also available in a variety of molecular weights (e.g., 36,000 to 4,000,000 Mv/g/mol) where the low weight PIB's are very tacking and the higher weights are not tacky at all but exhibit good cohesive strength.

Sample Preparation:

Mix Polyisobutylene from BASF with a solvent. Coat onto a three mil clear polyethylene terephthalate (PET) Film with Meyer rod. Let it dry 12 hours until the solvent has flashed off. Apply release liner over adhesive layer, place weight on sample and let sit for 24 hours. Cut samples to 8.5×11. Remove release liner, measure polarity with non-contacting electrostatic volt meter; apply decal to different surfaces that include, glass, smooth painted dry wall and ceiling, textured precast concrete wall.

Sample 1:

Mix 90 parts BASF Oppanol B-30 (low molecular weight, very tacky) with 10 Parts B-100 (high molecular weight FIB, no tack, good cohesive strength), 150 parts Toluene, coat with #28 Meyer rod, apply a smooth silicone release liner on paper back.

Results:

Adhesive layer was tacky to the touch, did not slide on glass, bonded immediately to the glass, difficult to reposition, had to break mechanical adhesive bond to move.

Sample 2:

Same adhesive blend as sample 1, apply a high release embossed micro taffeta polyethylene release liner

Results:

Adhesive layer was embossed with the micro taffeta pattern of the release liner. The embossed release liner transferred a pattern into the adhesive such that the adhesive was not tacky to touch. When the sample was brought approximately ½ inch from the window a strong electrical attraction occurred and the decal snapped onto the window. The decal was easy to rotate and slide on glass. The decal was then smoothed onto the glass with a wooden wallpaper edge roller. The decal could not be slid; the adhesive formed a mechanical bond with the glass surface. The decal could be easily peeled from the glass however and electrically attracted to the glass; the taffeta pattern was visible through the clear PET. 24 hours later the taffeta pattern was not visible, the bond was much stronger, the adhesive cold flowed onto the glass.

Sample 3:

Same adhesive test as Sample 2 but applied to a smooth painted wall and ceiling instead of glass.

Results:

The polarized adhesive electrostatically clung to the wall and ceiling, was easy to rotate. After 24 hours the adhesive cold flowed onto the painted dry wall creating a strong bond. After two weeks the bond was very strong yet it was removable and replaceable.

Sample 4:

Adhesive sample made of Oppanol® B-100 polyisobutylene and toluene, applied embossed high release micro taffeta polyethylene release liner.

Results:

The high release liner did not bond to the low tack B-100 polyisobutylene; because there was not a strong bond between the release liner and adhesive no contact electrification was observed. However when the B-100 was mechanically applied to glass and pressed down via hand pressure, the adhesive bonded to the glass. When this same sample was then removed from the glass a strong polarizing electric field was observed in the adhesive.

Sample 5:

Adhesive sample made of B-100 and polypropylene tight release liner with an embossed taffeta pattern.

Results:

The PIB bonded tightly to the release liner, when the liner was removed a strong polarized electric field occurred, it electrostatically adhered to the window and painted surfaces. After 24 hours the adhesive mechanically bonded to glass but was not tacky enough to bond to the painted surfaces. The adhesive cold flowed onto the glass and the taffeta embossed pattern disappeared. When this same label was removed from the glass a strong polarized field was observed, this time however the label did not slide on the glass because the embossed pattern was no longer on the surface of the adhesive.

Sample 6:

Adhesive sample made same as sample 2 but with clay coated paper top sheet instead of PET.

Results:

When the polypropylene release liner was removed the sample exhibited no contact electrification.

Sample 7:

Adhesive sample made same as sample 2 but with a PET (SKC company, type 94) film coated with an antistatic coating.

Results:

When the polypropylene release liner was removed the sample exhibited no contact electrification.

Sample 8:

Adhesive sample, from commercially available Fat Head Wall Coverings 3 mil vinyl with microsphere adhesive, paper liner with smooth silicone paper release liner.

Results:

Adhesive layer was tacky to the touch, did not slide on glass, no electrification feature, bonded immediately to the glass, difficult to reposition, had to break mechanical adhesive bond to move.

An article published in the Journal of Physics Applied Physics titled Contact Electrification of Insulating Materials (David Lacks and Mohan Sankuran) discuss properties necessary for Contact Electrifications. FIG. 2 in the journal provides examples of triboelectric series that shows an ordering of materials based on their empirically directed direction of charge transfer. This chart supports the data from the above samples. For example, in sample 6 the insulating adhesive did not achieve contact electrification when it was applied to clay coated paper. In the triboelectric series chart paper is shown to exhibit neutral polarity when exposed to contact electrification. Sample 4 became strongly electrified only after it was bonded to the glass, this supports the data in chart that suggests that glass and insulating polymers exhibit strong contact electrification.

Conclusion of Testing:

A strong polarized field can be developed in a pressure sensitive adhesive when:
The adhesive is made up of non-polar insulating polymers;
The release liner is an insulated material, having a tight release that tribolectrically charges the adhesive;
The face stock does not leak the electric charge faster than the label can be applied; and
The adhesive has a low or no tack surface; this can be done by a variety of methods, in this series of testing it was accomplished by embossing a texture into the adhesive.

Tack is the ability of the adhesive to instantaneously form a bond to a substrate using light contact pressure. The degree of tack can be controlled by the way the base polymer (e.g., polyisobutylene) is formulated into an adhesive system. The main factors that control tack are the average molecular weight of the polymers used in the formulation. Low molecular weight (high tack) polymers can be blended with high molecular weight (low tack) polymers of the same type to provide a range of tack.

Tack can also be affected by small amounts of additives. Tackifiers are generally added to pressure sensitive adhesives to increase the degree of tack and additives such as stearic acid, lanolin, or paraffin wax are added to an adhesive formulation to reduce tack.

According to certain embodiments of the present technology, it is generally desirable to have a low degree of tack to enable release of the release liner from the adhesive surface, yet a sufficient degree of tack to allow adherence to a secondary substrate after activation of the adhesive, e.g., by application of pressure.

In the context of the present technology, the following terms may be used to describe the behavior of adhesives that can be removed from the substrate at a selected time.
Removable refers to an adhesive bond that can withstand the rigors of service but in which the substrates can be purposefully detached leaving little or no adhesive residue. Removable adhesives generally cannot be reapplied once they are removed.
Permanent refers to an adhesive designed to adhere to a substrate for its entire service life. Permanent adhesives generally cannot be removed without damaging the substrate (and/or the adhesive assembly).
Repositionable adhesives are adhesives that maintain some short-term removability before becoming permanent. This feature may be beneficially when the adhesive assembly is misapplied and needs to be repositioned. Repositionable adhesives differ from removable adhesives in that they can be reapplied and eventually become permanent.

The present technology is applicable to all of the above adhesives, but, depending on the context, it may be preferable to use one type over the others. In certain embodiments of the present technology, it may be desirable to use repositionable adhesives that become permanent over time. For example, according to certain embodiments, the adhesive assembly is initially attached to a substrate such as a wall, by electrostatic attraction between the adhesive and the substrate. In this condition the adhesive is repositionable (i.e., the decal, tape, or wall covering can be removed or repositioned as required). However, once a reasonable pressure is applied, the decal, tape, or wall covering adheres by conventional pressure-sensitive adhesive mechanisms, and in this state, it is considered to be a permanent adhesive

While this disclosure has been described as having exemplary embodiments, this application is intended to cover any variations, uses, or adaptations using the general principles set forth herein. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

1. An adhesive assembly comprising a face stock having a top and bottom surface, said bottom surface of said film further comprising a preapplied activatable adhesive with a removable release liner, the release liner and the activatable adhesive being configured to electrostatically charge the activatable adhesive upon removal of the release liner from the adhesive.

2. An adhesive assembly according to claim 1, wherein the activatable adhesive and the release liner both comprise materials having a volumetric electrical resistivity greater than 1×10⁺¹⁰ Ω-m.

3. An adhesive assembly according to claim 1, wherein the electrostatic charge is applied to the activatable adhesive through contact electrification.

4. An adhesive assembly according to claim 1, wherein the electrostatic charge has a surface charge density sufficient to support the assembly on a vertical clean insulated surface.

5. An adhesive assembly according to claim 1, wherein the surface charge density is in the range of about ±0.01 μC/m² to about ±30 μC/m².

6. An adhesive assembly according to claim 5, wherein the surface charge density is in the range of about ±0.5 μC/m² to about ±10 μC/m².

7. An adhesive assembly according to claim 5, wherein the surface charge density is in the range of about ±2 μC/m² to about ±5 μC/m².

8. An adhesive assembly according to claim 1, wherein the adhesive maintains an electrostatic surface charge density of at least ±2 μC/m² for at least 12 hours.

9. An adhesive assembly according to claim 1, wherein the adhesive maintains a surface charge density of at least ±2 μC/m² for at least 1 hour.

10. An adhesive assembly according to claim 9, wherein the adhesive maintains a surface charge density of at least ±2 μC/m² for at least 1 minute.

11. An adhesive assembly according to claim 1, wherein the activatable adhesive is a pressure sensitive adhesive.

12. An adhesive assembly according to claim 11, wherein the pressure sensitive adhesive comprises non-tacky projections from a pressure sensitive adhesive surface

13. An adhesive assembly according to claim 1, wherein the activatable adhesive is pattern coated on said bottom surface of the film.

14. The adhesive assembly according to claim 9, wherein the activatable adhesive is microencapsulated.

15. An adhesive assembly according to claim 1, wherein the activatable adhesive is heat activated.

16. An adhesive assembly according to claim 1, wherein the sheet is a laminate comprising an image receptive layer on the top surface of the film.

17. An adhesive assembly according to claim 1, wherein the sheet is a pre-imaged wall covering.

18. A method of applying an adhesive assembly of claim 1 to a display substrate, comprising:
a) electrostatically charging the activatable adhesive through contact electrification by removing the release liner from the sheet;
b) applying the bottom surface of the film to the intended location on the display substrate, thereby temporarily attracting the sheet to the display substrate through the electrostatic charge of the film;
c) orienting said sheet on the display substrate; and
d) securely adhering the sheet to the display substrate by activating the activatable adhesive.

19. The method of claim 18, wherein the activatable adhesive is microencapsulated, and wherein the adhesive is released from said microcapsules after orienting the sheet on the display substrate.

20. The method of claim 18, wherein the activatable adhesive is a pressure sensitive adhesive that is activated by pressure, and wherein the adhesive is activated by applying pressure to the sheet at the location of the adhesive after orienting the sheet on the display substrate.

21. The method of claim 19, wherein the activatable adhesive is a heat activated adhesive, and wherein the adhesive is activated by applying heat to the sheet after orienting the sheet on the display substrate.

22. A rolled adhesive tape, comprising:
a film having a top and bottom surface, the top surface having an embossed pattern;
an activatable adhesive applied to the bottom surface of the film;
wherein, when the tape is rolled upon itself, the embossed pattern from the top surface is transferred to the adhesive; and
wherein, when the tape is unrolled, the activatable adhesive is electrostatically charged by contact electrification with the top surface of the film.

23. A rolled adhesive tape according to claim 22, wherein the activatable adhesive is a pressure sensitive adhesive.

24. A rolled adhesive tape according to claim 22, wherein the activatable adhesive is heat activated.

25. A rolled adhesive tape according to claim 22, wherein the electrostatic charge has a charge density sufficient to support the tape on vertical clean insulated surface.
